(19) United States
(12) Patent Application Publication
(10) Pub. No.: US 2017/0223507 A1
(43) Pub. Date: Aug. 3, 2017

(54) MONITORING RELATIVE LOCATIONS OF MOBILE DEVICES ENROLLED IN A CAR POOLING PLAN

(71) Applicant: Commuute, Lynwood, WA (US)

(72) Inventor: Brett Turner, Encinitas, CA (US)

(21) Appl. No.: 15/419,785

(22) Filed: Jan. 30, 2017

Related U.S. Application Data
(60) Provisional application No. 62/289,136, filed on Jan. 29, 2016.

(51) Int. Cl. H04W 4/02; G06Q 50/30; H04W 8/00

(52) U.S. Cl. CPC H04W 4/028; H04W 8/005; H04W 4/023; H04W 4/021; G06Q 50/30

(57) ABSTRACT

Facilitating participation in and management of an aggregated carpooling incentive plan for users by discovering, by a first mobile computing device of a first user participating in a carpooling competition, a second mobile computing device associated with a second user participating in the carpooling competition, determining a distance between the first mobile computing device and the second mobile computing device, assessing whether the determined distance is within a threshold vehicle boundary metric, and registering that the first user and the second user are carpooling based on a determination that the first mobile computing device and the second mobile computing device are within the threshold vehicle boundary metric. Verification of participation can include determining, based on the geographic location information of the first and second mobile computing devices whether the users commuted from a home location to a work location.

### CROSS-REFERENCE TO RELATED APPLICATIONS

This application claims priority to and the benefit of U.S. Provisional Patent Application No. 62/289,136 filed on Jan. 29, 2016 and titled “INCENTIVIZED CAR POOL MANAGEMENT: HOSTING, AGGREGATING DISTRIBUTING FUNDS, AND VERIFYING COMPLIANCE,” the disclosure of which is incorporated herein by reference in its entirety.

### TECHNICAL FIELD

The subject matter described herein relates to providing systems and methods for facilitating car pooling among commuters.

### BACKGROUND

There are thousands of incentive-based programs directed by private enterprise and government organizations to encourage daily commuters to carpool. These programs are largely disparate and target the individual. Unfortunately, submitting a form to save $2 for the day isn't enough of a monetary incentive to overcome the freedom we enjoy as individuals of driving our cars to work.

With the ubiquity of mobile computing devices, mobile computing technology can be employed to facilitate the provision of incentives to commuters for car pooling.

### SUMMARY

The presently described subject matter facilitates the aggregation of funds from incentive-based programs for commuters, savings experienced by each commuter, or from general advertising or sponsorship, into a pool of funds. Contests can be facilitated through mobile computing devices, web-based applications, or the like, that award cash and prizes from the pool in larger more compelling increments. The contests can be hosted as a social network and winners can be selected by the users themselves. The host may act as the agent on behalf of the commuters to seek incentive-based or other funds to increase the size of the pooled funds either with the commuters or independently.

The presently described subject matter facilitates verifying user participation in the car pooling program. Presently described subject matter can facilitate provision of an authentication algorithm to ensure that each user is in fact carpooling. For example, mobile computing device can include user equipment-to-user equipment communication technology, geolocation technology, or peer-to-peer technology.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an [[enterprise resource software system or other business software solution or architecture]], it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a system having one or more features consistent with the present description;

FIG. 2 is a system having one or more features consistent with the present description;

FIG. 3 is a method having one or more features consistent with the present description;

When practical, similar reference numbers denote similar structures, features, or elements.

### DETAILED DESCRIPTION

The ubiquity of mobile computing devices allows the application of mobile computing technology to facilitate the provision of incentives to commuters for car pooling. Presently described are systems, methods, computer program products, and the like, that facilitate the provision of incentives to commuters for carpooling, and facilitate the verification of the occurrence of carpooling among commuters.

The presently described subject matter facilitates the aggregation of funds from incentive-based programs for commuters, savings experienced by each commuter, or from general advertising or sponsorship, into a pool of funds. Contests can be facilitated through mobile computing devices, web-based applications, or the like, that award cash and prizes from the pool in larger more compelling increments. The contests can be hosted as a social network and winners can be selected by the community of users themselves.

The presently described subject matter facilitates verifying user participation in the car pooling program. Presently described subject matter can facilitate provision of an authentication algorithm to ensure that each user is in fact carpooling. For example, mobile computing device can include user equipment-to-user equipment communication technology, or peer-to-peer technology. Signal strengths between two mobile computing devices can facilitate a determination of a likely distance between the two mobile computing devices. The determined distance between the mobile computing devices can verify that the mobile computing devices are within sufficient proximity to make it feasible that the mobile computing devices are within a vehicle.

The mobile computing devices can include geolocation technology. The geolocation technology can facilitate determination of the geographical location of the mobile computing device. The geolocation technology can rely on time-stamped signals received from geolocation satellites, for example, GPS satellites. The geolocation technology can rely on time-stamped signals received from one or more base stations. The geolocation technology can rely on the receipt of one or more signals from one or more base stations and triangulation techniques to determine the location of the mobile computing device.

The measurement of the location of the mobile computing device over a period of time can verify that the user of the mobile computing device is on a commute to work. The measurement of the location of the mobile computing device over a period of time can verify that the user is within a certain threshold proximity to another user during the commute of the users.

A computer program product can be provided to facilitate one or more elements of the presently described subject matter. The computer program product can be configured to be implemented on mobile computing devices. One or more elements of the presently described subject matter can be supported by a server. The server can be configured to facilitate aggregation of information gathered by the mobile computing devices.

An application can be provided for execution on a user device. The application can be configured to cause the user device to perform one or more operations. The application can be configured to facilitate registration of user's with one or more third-party commuter incentive plans. The third-party commuter incentive plans can be managed by third-party providers. The application can be configured to manage and record the incentive plans that the user is registered with.

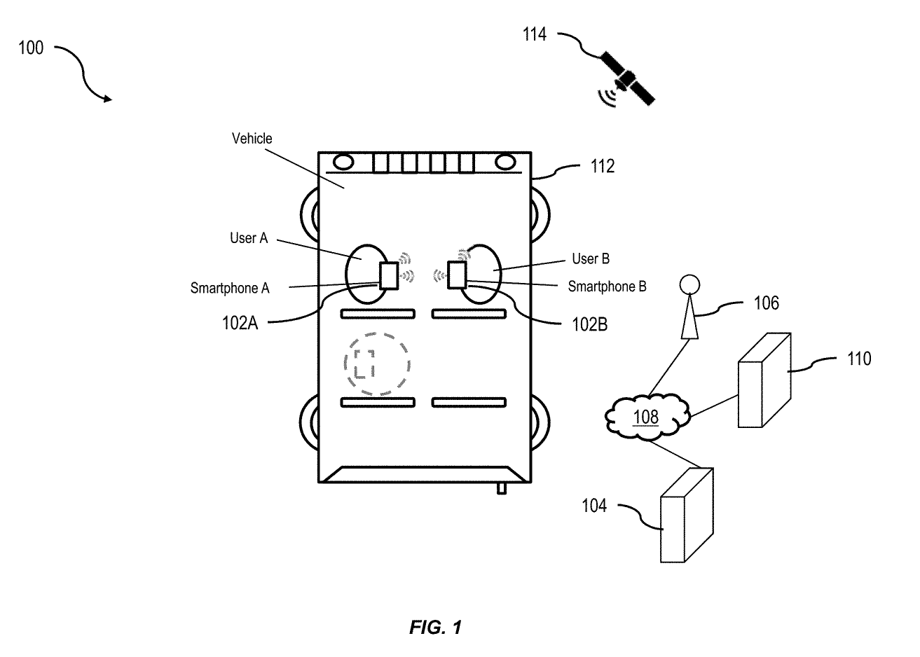

FIG. 1 is an illustration of a system 100 for facilitating tracking and verification of commuter actions, having one or more features consistent with the present description. In some variations, an application can be provided for execution on one or more mobile computing devices 102A and 102B. A mobile computing device can include a cell phone, smartphone, smartwatch, tablet, laptop, netbook, or the like. The mobile computing device can have electronic data storage configured to store computer instructions, which, when executed by the one or more processors of the mobile computing device, can cause the mobile computing device to perform one or more operations.

The operations caused to be performed by the application executed on one or more mobile computing devices 102A and 102B can be supported by one or more operations performed by a server 104. The mobile computing devices 102A and 102B can send and receive wireless signals from a base station 106. The base station 106 can be in electronic communication with the Internet 108. The server 104 can be in electronic communication with the Internet 108. Thus, communications between the mobile computing devices 102A and 102B and the server 104 are facilitated.

One or more of the operations attributed to the application in the present disclosure can be performed by the server, the mobile computing device, other components of system 100, or the like.

The application can be configured to verify compliance, by users of a mobile computing device executing the application, with a carpooling incentive plan.

In some variations, The application can be configured to facilitate aggregation of financial incentives for individuals to commute together. For example, an individual or group of individuals who carpool to and from their place of work for their daily commute can be provided financial incentives to do so. Aggregation of the financial incentives for the individual or group of individuals can form a larger financial incentive pool of funds for those individuals. The funds can be awarded in connection with a contest, random drawing, or other distribution method. The recipient(s) of the awards can be fewer in number than the fund contributors.

The application can be configured to act as the agent for individuals or groups of individuals who carpool to and from their place of work and who are therefore eligible to receive an incentive-based financial payment or expense reimbursement from a city or state or federal governmental agency such as the Department of Transportation (DOT), government grant program, employer, or any other organization, government agency, non-profit, or public or private corporation. Acting as an agent for such carpooling individuals or group of individuals, the mobile application or its affiliated systems or administrators, may complete and submit forms to such organizations on the carpooling individuals' behalf and receive any related funds on their behalf. Such submissions may be to organizations either known to the carpooling individuals or not.

The application can be configured to facilitate engagement with businesses to sponsor contests. The application can be configured to facilitate the running of competitions and manage the disbursement of pooled funds to individuals or groups of individuals who win the competitions.

Sponsorship of the competitions can benefit the sponsoring business. The sponsoring business can provide funds that would go into the pool of funds for the competition. The application can be configured to advertise the sponsor, thereby providing advertising and/or public relations benefits for the sponsor.

The application can be configured to verify that the participants, user A and user B, in the carpooling competition are carpooling in a vehicle 112. The application can include one or more carpool authentication algorithm(s), software program(s), or compliance system(s). The application executed on a mobile computing device can be configured to facilitate determination of whether or not the user is riding in a vehicle with one more others users to ensure that users are meeting carpool definitions, requirements, or objectives, in compliance with the competition. The definitions, requirements, or objectives, can be defined by a third-party organization or the application company itself.

A first mobile computing device 102A and a second mobile computing device 102B can include an machine readable instructions configured to facilitate verification that users participating in the commuter competition are carpooling. The machine readable instructions can include a carpool authentication algorithm(s). In some variations, the first mobile computing device 102A can be configured to discover the second mobile computing device 102B. The machine-readable instructions can be configured to facilitate discovery using one or more technical features of the first mobile computing device 102A and the second mobile computing device 102B. The one or more technical features can be provided by software and/or hardware components of the first mobile computing device 102A and the second mobile computing device 102B.

The machine-readable instructions can be configured to facilitate a determination of the distance between the first mobile computing device 102A and the second mobile computing device 102B. In some variations, the distance between the first mobile computing device 102A and the second mobile computing device 102B can be determined based on peer-to-peer communication technology. For example, the strength of a peer-to-peer signal can facilitate a determination of the distance between the first mobile computing device 102A and the second mobile computing device 102B. As another example, a message including a timestamp indicating the time that the message was transmitted from one of the mobile computing devices can be received by the other mobile computing device and the time of receipt can be noted. The time difference between when the message was transmitted and when the message was received can facilitate a determination of the distance between the first mobile computing device 102A and the second mobile computing device 102B. The peer-to-peer communication protocols can include one or more of Wi-Fi Direct, Bluetooth, or other P2P communication protocols.

The distance between the first mobile computing device 102A and the second mobile computing device 102B can be determined based on geolocation technology of the first and second mobile computing devices. Geolocation technology can be configured to receive one or more signals from a geolocation satellite 114. The first mobile computing device 102A and the second mobile computing device 102B can be configured to transmit time-of-receipt information for one or more signals received from the gelocation satellite 114. Based on a difference in the time-of-receipt information a distance between the first mobile computing device 102A and the second mobile computing device 102B can be determined.

In some variations, the distance between the first mobile computing device 102A and the second mobile computing device 102B can be determined based on one or more signals received from one or more base stations 106 at the first mobile computing device 102A and the second mobile computing device 102B. For example, a signal received from base station 106 at the first mobile computing device 102A can have a different strength or a different time-delay than the same signal received from the base station 106 at the second mobile computing device 102B. This different time-delay can be used to determine the distance between the first mobile computing device 102A and the second mobile computing device 102B. Such signals between the first mobile computing device 102A and the second mobile computing device 102B and the base station 106 can include Wi-Fi, cellular, or other carrier, WAN/LAN communication methods, or the like.

An assessment can be made as to whether the determined distance between the first mobile computing device 102A and the second mobile computing device 102B is within a threshold vehicle boundary metric. The threshold vehicle boundary metric can be based on standard vehicle measurements. The threshold vehicle boundary metric can be dynamic, changing based on the vehicle being used to transport the users along their commute. For example, if a bus is being used to transport the users, then the threshold vehicle boundary metric can be set to a level comparative to a bus, if a motorcycle is being used to transport the users, then the threshold vehicle boundary metric can be set to a level comparative to a bike.

User A and User B can be registered as carpooling, the first mobile computing device 102A and/or the second mobile computing device 102B, based on a determination that the first mobile computing device 102A and the second mobile computing device 102 B are within the threshold vehicle boundary metric.

Using geolocation technology of the first mobile computing device 102A and/or the second mobile computing device 102B, a distance traveled by the first mobile computing device 102A and the second mobile computing device 102B can be determined.

The geolocation technology of first mobile computing device 102A and the second mobile computing device 102B can include geolocation satellite signal receivers, terrestrial signal transceivers, or the like. The geolocation technology of first mobile computing device 102A and the second mobile computing device 102B can include hardware, software, firmware, or the like.

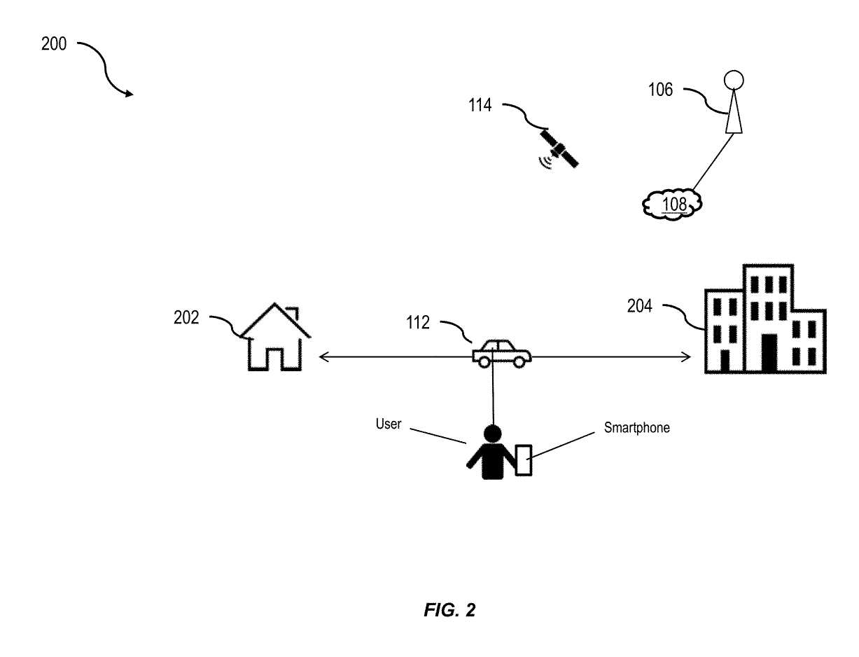

FIG. 2 is an illustration of a system 200 having one or more features consistent with the present subject matter. The application can be configured to cause the first mobile computing device 102A and the second mobile computing device 102B, server 104, or the like, to reference one or more roadmaps to determine that User A and User B commuted to work. For example, the geolocation information of the first mobile computing device 102A can include an indication that the first mobile computing device 102A, and by association User A, started the journey at a home address 202 associated with User A. Similarly, the geolocation information of the second mobile computing device 102B can include an indication that the second mobile computing device 102B, and by associated User B, started the journey at a home address associated with User B. The geolocation information associated with the first mobile computing device 102A can include an indication that the first mobile computing device 102A completed the journey at a work address 204 associated with User A. The same can be true for the geolocation information of the second mobile computing device 102B. Throughout the journey it can be determined that the first mobile computing device 102A was within a threshold vehicle boundary metric with the second mobile computing device 102B. Consequently, it can be deduced that User A and User B commuted together during that journey.

In some variations, the roadmaps can be provided by third-party services. Such third-party services can include one or more servers 110 for access over the Internet 108.

The first mobile computing device 102A, second mobile computing device 102B, server 104, or one or more other computing devices can each include one or more processors. The processor(s) can be configured to provide information processing capabilities to a computing device having one or more features consistent with the current subject matter. The processor(s) may include one or more of a digital processor, an analog processor, a digital circuit designed to process information, an analog circuit designed to process information, a state machine, and/or other mechanisms for electronically processing information. The processor(s) can be a single entity or the processor(s) can include a plurality of processing units. These processing units may be physically located within the same device, or the processor(s) may represent processing functionality of a plurality of devices operating in coordination. The processor(s) may be configured to execute machine-readable instructions, which, when executed by the processor(s) may cause the processor(s) to perform one or more of the functions described in the present description. The functions described herein may be executed by software; hardware; firmware; some combination of software, hardware, and/or firmware; and/or other mechanisms for configuring processing capabilities on the processor(s).

The first mobile computing device 102A, second mobile computing device 102B, server 104, or one or more other computing devices can include electronic storage. Electric storage may comprise electronic storage media that electronically stores information. The electronic storage media of electronic storage xx may include one or both of system storage that is provided integrally (i.e., substantially non-removable) with a computing device and/or removable storage that is removably connectable a computing device via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). Electronic storage may store software algorithms, information determined by the processor(s), information received from one or more computing devices, information that enables the one or more computing device to function, or the like.

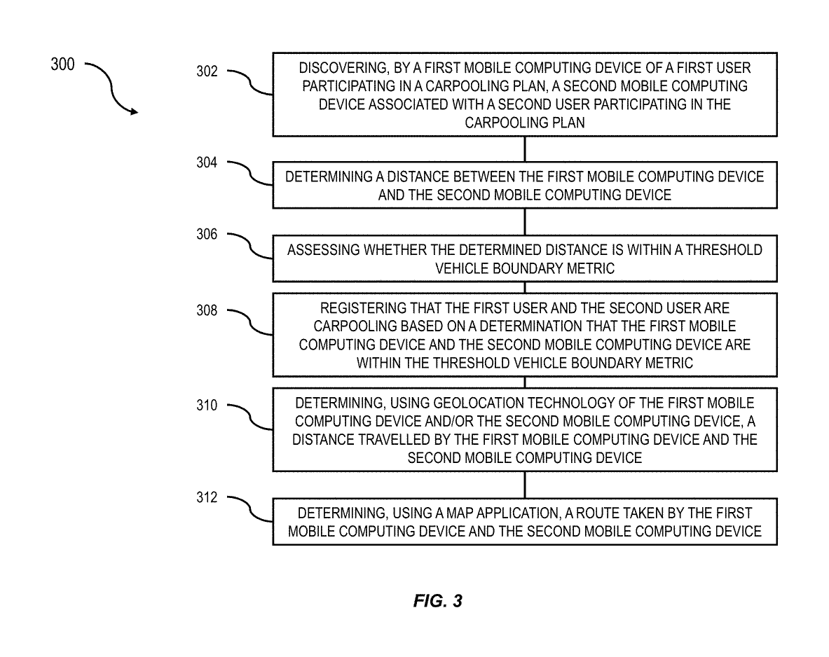

FIG. 3 illustrates a method 300 having one or more features consistent with then current subject matter. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At 302, a first mobile computing device of a first user participating in a carpooling plan can discover a second mobile computing device associated with a second user participating in the carpooling plan. In some variations, the carpooling plan can be a carpooling competition.

At 304, a distance between the first mobile computing device and the second mobile computing device can be determined.

At 306, an assessment can be made as to whether the determined distance is within a threshold vehicle boundary metric.

At 308, the determination that the first user and the second user are carpooling can be registered, based on a determination that the first mobile computing device and the second mobile computing device are within the threshold vehicle boundary metric.

At 310, a distance traveled by the first mobile computing device and the second mobile computing device can be determined using geolocation technology of the first mobile computing device and/or the second mobile computing device.

At 312, a route taken by the first mobile computing device and the second mobile computing device can be determined using a map application.

Without in any way limiting the scope, interpretation, or application of the claims appearing herein, a technical effect of one or more of the example embodiments disclosed herein may include: verifying the proximity of mobile computing device belonging to a plurality of users participating in a carpooling competition; determining a distance traveled by such proximate mobile computing devices; managing participation in carpooling incentive plans, and the like.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method to be performed by at least one computer processor forming at least a part of a computing system, the method comprising:
discovering, by a first mobile computing device of a first user participating in a carpooling plan, a second mobile computing device associated with a second user participating in the carpooling plan;
determining a distance between the first mobile computing device and the second mobile computing device;
assessing whether the determined distance is within a threshold vehicle boundary metric; and,
registering that the first user and the second user are carpooling based on a determination that the first mobile computing device and the second mobile computing device are within the threshold vehicle boundary metric.

2. The method of claim 1, wherein the carpooling plan is a carpooling competition.

3. The method of claim 1, further comprising:
determining, using geolocation technology of the first mobile computing device and/or the second mobile computing device, a distance traveled by the first mobile computing device and the second mobile computing device.

4. The method of claim 3, further comprising:
determining, using a map application, a route taken by the first mobile computing device and the second mobile computing device.

5. The method of claim 1, wherein determining the distance between the first mobile computing device and the second mobile computing device includes measuring, at the first mobile computing device, a signal strength of a signal transmitted by the second mobile computing device.

6. The method of claim 1, wherein determining the distance between the first mobile computing device and the second mobile computing device includes determining a difference between a time of transmission of a signal from a first mobile computing device and a time of receipt of the signal at the second mobile computing device.

7. The method of claim 1, wherein the first mobile computing device and the second mobile computing device include geolocation technology and determining the distance between the first mobile computing device and the second mobile computing device includes using the geolocation technology.

8. The method of claim 1, wherein the geolocation technology includes satellite signal receivers.

9. The method of claim 1, wherein the geolocation technology includes base station signal receivers.

10. The method of claim 1, further comprising:
receiving an indication of a type of vehicle being used by first user and the second user to make their commute; and,
adapting the threshold vehicle boundary metric based on the indicated type of vehicle.

11. The method of claim 1, further comprising:
transmitting a confirmation to a server that the first user and the second user are carpooling in response to registering that the first user and the second user are carpooling.
